(19) United States
(12) Patent Application Publication
(10) Pub. No.: US 2019/0017130 A1
(43) Pub. Date: Jan. 17, 2019

(54) METHOD FOR COLORING STAINLESS STEEL

(71) Applicant: Steel Stone Memories, LLC, Cassville, MO (US)

(72) Inventor: Ryan L. Preddy, Cassville, MO (US)

(21) Appl. No.: 16/028,644

(22) Filed: Jul. 6, 2018

Related U.S. Application Data
(60) Provisional application No. 62/532,000, filed on Jul. 13, 2017.

(51) Int. Cl. C21D 1/00

(52) U.S. Cl. CPC C21D 1/00; B44C 1/22

(57) ABSTRACT

The present disclosure relates to a method for coloring a stainless steel object. The method includes a mechanical step of abrading the surface of a stainless steel object to be colored, slowly heating the object to a predetermined temperature, slowly cooling the object to a predetermined temperature, cleaning and then sealing the object for use. Color is controlled by the degree of abrasion imparted on the stainless steel during the mechanical process. Coarse abrasion results in blue colors while fine abrasions result in copper, gold and bronze colors. Once abraded, the stainless steel is heated slowly in a convection oven to approximately 940° Fahrenheit to fix the color. The device is then slowly cooled to approximately 125° Fahrenheit which stabilizes the stainless steel for use. After cooling the stainless steel can be cleaned with phosphate and sealed using conventional powder coating methods.

### CROSS-REFERENCE TO RELATED APPLICATIONS

This application claims priority to U.S. Provisional Patent Application No. 62/532,000, filed Jul. 13, 2017, the disclosures of each of which are incorporated by reference herein in its entirety.

### BACKGROUND

The present invention relates to a method for coloring stainless steel using a combination of mechanically altering a surface of an object manufactured from stainless steel and then chemically altering the object by heating it to a specific temperature over time. The method allows a user to develop specific color palettes on a stainless steel object with substantial control over the process.

It is generally known that the color of stainless steel can be altered by heat tempering. Tempering at specific temperatures can provide subtle color changes on the surface of the steel. However, the color variations are subtle and it is very difficult to control temperature to create a specific color on the stainless steel. Moreover, stainless steel is prone to warping during the heating and cooling of the product absent precise control.

It is highly desirable to develop specific colors on stainless steel products for common items, particularly kitchen and bathroom fixtures manufactured from stainless steel. The inventive method works particularly well to colorize stainless steel sink basins, but can be successfully used for virtually any product manufactured from stainless steel.

The instant invention was derived from substantial experimentation and presents a novel method for colorizing stainless steel with a combination of mechanical and chemical changes to stainless steel objects. The method overcomes known drawbacks and limitations of conventional heat tempering colonization of stainless steel by providing an innovative method that is easy to replicate, provides consistent results and is cost effective. Moreover, the developed colors using this method are significantly more dramatic than the subtle color changes created with known heat tempering methods.

### SUMMARY

Embodiments of the present disclosure relate to a method for coloring stainless steel. The inventive method includes a mechanical and chemical method for colorization of stainless steel. The stainless steel to be colored is first mechanically altered by abrading the stainless steel using a predetermined degree of abrasion. This abrasion is generally imparted by using sandpaper or a similar abrasive materials known within the industry. The color to be achieved is controlled by the grit of the sandpaper used. For example, 36 sandpaper imparts blue and purple colors, 60 grit sandpaper imparts a copper color, 80 grit sandpaper imparts a gold color, 120 grit sandpaper imparts a bronze color. Abrasion can also be achieved using more than one grit so that multiple colors can be imparted on the finished product. After the mechanical step a chemical process of slowly heating and cooling the stainless steel achieves the final colorization. It is preferable that the stainless steel be heated slowly over a period of approximately 30 minutes beginning at room temperature and ending at approximately 940° Fahrenheit. During the heating process air is circulated around the stainless steel object being colored. When the stainless steel is heated to approximately 940° Fahrenheit color is set and the stainless steel can be slowly cooled. Once cooled, the stainless steel can be cleaned using phosphate and then powder coated to protect the end product.

This process and method is particularly well suited to stainless steel fixtures commonly found in kitchens and bathrooms such as basin sinks. It can also be used on countertops, bathtubs, or virtually any other stainless steel appliance or product.

### DETAILED DESCRIPTION

The inventive method for coloring stainless steel includes steps to mechanically alter the surface of the stainless steel to be colored and imparting chemical changes on the stainless steel by slowly heating and then slowly cooling the stainless steel. While the process can be used for virtually any stainless steel, the methodology works best on 16-20 gauge stainless. Very thin or very thick stainless steel tends to warp during the heating and cooling process. Moreover, stainless steel having high nickel content may adversely impact the results of this coloring process.

It has been determined that abrading the surface of stainless steel prior to the step of slowly heating it to a high temperature affords very specific control of colorization of the stainless steel. Roughly abraded stainless steel tends to color in the blue to purple range while more finely abraded stainless steel tends to color copper, gold and then bronze depending on the degree of abrasion.

Generally, the inventive method includes the steps of cleaning the stainless steel to remove any manufacturing residue or chemicals. The following step includes abrading the surface of the stainless steel to be colored using a preselected abrasive material. For purposes of this disclosure, the preferred method for abrading the surfaces of the stainless steel is the use of non-stearated sandpaper. All references to sandpaper grit size are pursuant to the European Federation of European Producers of Abrasive “P” Grade. The step of abrading the stainless steel can be achieved by hand sanding or use of any variety of powered sanders. It has also been determined that combining different sandpaper grits during the abrading process can result in the inclusion of multiple colors from the process. For example, abrading the stainless steel using 60 grit sandpaper will result in copper colorization and abrading at 120 grit sandpaper imparts a bronze color during the method. Combining the 60 grit and 120 grit sandpaper during the abrading process results in a combination of copper and bronze colorization.

It should also be understood that the abrading step can be achieved with methods varying from the use of sandpaper and it is the intention of this application to encompass all methods of abrading stainless steel including all mechanical and chemical processes. It is also possible to achieve specific predetermined patterns of color on the stainless steel by abrading within templates, overlays, jigs or other devices that allow control of the area of being abraded.

Following the step of abrading the stainless steel to be colored, the object is placed in a cool (room temperature) oven. The oven should have convection features to cause circulation of air during the heating process. The temperature of the oven is slowly increased over a controlled period of time at a controlled rate so that the stainless steel object is gradually heated. It is known that rapid heating of stainless steel results in substantial structural changes including irreversible warping. Moreover, rapid heating and cooling of stainless steel can result in the item becoming brittle which can affect usability of the object.

In one embodiment of the method, the oven temperature is increased so that the temperature of the stainless steel object rises to approximately 380° Fahrenheit over a five minute period of time. In this embodiment, when the stainless steel reaches approximately 380° Fahrenheit the convection feature of the oven is initiated and hot air is circulated around the stainless steel item. Then oven temperature is increased so that the temperature of the stainless steel object rises to approximately 400° Fahrenheit over a period of approximately five minutes. The oven temperature continues to increase over a period of approximately eight minutes until the stainless steel object reaches a temperature of approximately 640° Fahrenheit. The temperature is again slowly increased in the oven until a final peak temperature of the stainless steel object of approximately 940° Fahrenheit is achieved. At this point the desired color should be visibly apparent on the stainless steel surfaces that have been abraded.

Once the desired colorization is achieved, the temperature of the object must be cooled over a controlled time at a controlled rate. To achieve the desired cooling time, the oven may be turned off and allowed to slowly cool or the temperature of the oven can be slowly decreased over a period of time. It is important that the stainless steel is not rapidly cooled.

It is preferred that the cooling process allows the temperature of the stainless steel object to decrease to approximately 125° Fahrenheit before it is removed from the oven. At this point the stainless steel is stable enough to further process as desired without damaging it. Once the stainless steel object has cooled to at least 125° Fahrenheit it is cleaned, preferably by dipping it in phosphate or otherwise applying phosphate to the surface of the stainless steel. After this cleaning step the stainless steel can be sealed via a powder coating process.

An example of a the method of performing the method of the invention is described in detail in Table 1. The embodiment of the process described in Table 1 takes approximately 53 minutes to complete the temperature cycle. The time periods and temperature rate increases may be adjusted based on the size, mass, shape, or configuration of the object.

TABLE 1

| | | |
|---|---|---|
| | Oven | Stainless |
| Minute | temperature | temperature |

Begin heating using 5 lbs gas pressure

| | | |
|---|---|---|
| 1 | 215 | 125 |
| 2 | 312 | 148 |
| 3 | 333 | 162 |
| 4 | 365 | 172 |

Place lids on

| | | |
|---|---|---|
| 5 | 382 | 195 |
| 6 | 415 | 264 |
| 7 | 434 | 300 |
| 8 | 463 | 324 |
| 9 | 474 | 371 |
| 10 | 495 | 394 |

Increase gas pressure to 7 lbs

| | | |
|---|---|---|
| 11 | 549 | 422 |
| 12 | 631 | 485 |
| 13 | 709 | 534 |
| 14 | 743 | 582 |
| 15 | 764 | 604 |
| 16 | 789 | 620 |
| 17 | 818 | 629 |
| 18 | 820 | 638 |
| 19 | 829 | 688 |
| 20 | 848 | 691 |
| 21 | 902 | 770 |
| 22 | 949 | 805 |
| 23 | 960 | 833 |
| 24 | 989 | 855 |
| 25 | 997 | 882 |
| 26 | 998 | 891 |
| 27 | 1015 | 921 |
| 28 | 1025 | 935 |
| 29 | 1025 | 937 |
| 30 | 1025 | 938 |

Begin cooling process - oven turned off

| | | |
|---|---|---|
| 5 | 277 | 288 |
| 10 | 219 | 224 |
| 15 | 180 | 182 |
| 20 | 145 | 168 |

Comprise, include, and/or plural forms of each are open ended and include the listed parts and can include additional parts that are not listed. And/or is open ended and includes one or more of the listed parts and combinations of the listed parts. Changes may be made in the above methods, devices and structures without departing from the scope hereof.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

One skilled in the art will realize that the present disclosure may be embodied in other specific forms without departing from the spirit or essential characteristics thereof. The foregoing embodiments are therefore to be considered in all respects illustrative rather than limiting of the present disclosure. Scope of the present disclosure is thus indicated by the appended claims, rather than by the foregoing description, and all changes that come within the meaning and range of equivalency of the claims are therefore intended to be embraced therein.

What is claimed is:

1. A method for coloring an object manufactured from stainless steel, comprising the steps of: cleaning the object, abrading a portion of a surface of the object, heating the object at a controlled rate over a predetermined period of time until the temperature of the object reaches a peak temperature, and cooling the object at a controlled rate over a predetermined period of time to a predetermined temperature.

2. The method of claim 1 adding the step of powder coating the object after the step of cooling.

3. The method of claim 1 wherein the step of abrading a portion of the surface of the object comprises sanding the portion of the surface with sandpaper having a grit between approximately 12 to approximately 220.

4. The method of claim 3 wherein the step of abrading includes a combination of sanding steps, each step using a different grit of sandpaper.

5. The method of claim 1 wherein the peak temperature is between approximately 900° F. and approximately 950° F.

6. The method of claim 5 wherein the peak temperature is approximately 938° F.

7. The method of claim 1 wherein the temperature of the object is increased at a rate of less than 200° F. every five minutes.

8. The method of claim 1 wherein the heating of the object begins in an convection oven at room temperature.

9. The method of claim 1 further comprising the step of circulating air around the object during the heating step.

10. The method of claim 1 wherein the step of abrading a portion of a surface of an object comprises the steps of selecting the grit of sandpaper to develop a desired color for the object.

11. The method of claim 10 wherein selecting a grit of sandpaper of approximately 36 grit develops blue and purple colors, approximately 60 grit to develop copper colors, approximately 80 grit to develop gold colors, or approximately 120 grit to develop bronze colors.

12. A method for coloring a portion of a surface of an object manufactured from stainless steel, comprising the steps of:
abrading a portion of the surface of the object,
placing the object in an oven,
heating the object at a controlled rate during a heating period to a temperature of approximately 938° F.,
cooling the object at a controlled rate during a cooling period to approximately 125° F. during a cooling period.

13. The method of claim 12 wherein the duration of the heating period is approximately 30 minutes, and the duration of the cooling period is approximately 25 minutes.

14. The method of claim 13 further comprising the step of circulating air around the object during the heating period.

15. The method of claim 14 further comprising the step of circulating air around the object during the cooling period.

16. The method of claim 12 further comprising the step of cleaning the portion of the surface of the object with alcohol prior to the step of abrading.

17. The method of claim 16 further comprising the step of applying phosphate to the surface of the object after the step of cooling the object.

18. The method of claim 17 further comprising the step of powder coating the object after the step of applying phosphate to the object.
